(19) United States
(12) Patent Application Publication
(10) Pub. No.: US 2026/0159686 A1
(43) Pub. Date: Jun. 11, 2026

(54) PC RESIN COMPOSITION FOR LIDAR COVER AND MOLDED ARTICLE OR LIDAR COVER MANUFACTURED USING SAME

(71) Applicants: HYUNDAI MOTOR COMPANY, Seoul (KR); KIA CORPORATION, Seoul (KR); SAMYANG CORPORATION, Seoul (KR); ECOPLASTIC CORPORATION, Gyeongju-si (KR)

(72) Inventors: Seon-Yong AN, Hwaseong-si (KR); Sae-Ah KIM, Hwaseong-si (KR); Kyoung-Chun KWEON, Hwaseong-si (KR); Duck-Hee LEE, Daejeon (KR); Myung-Gi LEE, Daejeon (KR); Gyeom-Son SEONG, Gunpo-si (KR); Jung-Kyu HAN, Sejong-si (KR); Tae-Jin AN, Seoul (KR); Wan-Ho SON, Gunpo-si (KR)

(21) Appl. No.: 19/214,845

(22) Filed: May 21, 2025

(30) Foreign Application Priority Data
Dec. 5, 2024 (KR) 10-2024-0179338

(51) Int. Cl. C08L 69/00

(52) U.S. Cl. CPC C08L 69/00; C08L 2203/206

(57) ABSTRACT

A polycarbonate resin composition for a light detection and ranging (LiDAR) sensor cover includes a polycarbonate resin and an isosorbide resin. The isosorbide resin is present in an amount that is greater than or equal to 0.5 wt % and less than or equal to 1.0 wt %, based on a total wt % of the PC-based resin composition.

### CROSS-REFERENCE TO RELATED APPLICATION

This application claims priority to Korean Patent Application No. 10-2024-0179338, filed on Dec. 5, 2024, the disclosure of which is incorporated herein by reference in its entirety.

### TECHNICAL FIELD

The present disclosure relates to a polycarbonate (PC)-based resin composition applicable to light detection and ranging (LiDAR) sensors, including those used in the vehicles, and a molded article manufactured using the composition.

### BACKGROUND

With the increasing importance of autonomous driving, a vehicle may be equipped with a light detection and ranging (LiDAR) unit to detect obstacles around the vehicle. The LiDAR unit may be located at the front and top sides of the vehicle and may emit infrared light to detect a front side object in response to the light reflected from the object.

### SUMMARY

In some examples, a polycarbonate resin composition may include a combination of a polycarbonate resin, a polysiloxane-polycarbonate copolymer, and a polycondensation reaction product of a diol component including an aliphatic diol having a cycloalkylene group and a dicarboxylic component, which is an aromatic dicarboxylic compound.

However, after insert injection of the polycarbonate-based resin and metallic film, insufficient adhesion between the metallic film and polycarbonate-based resin may cause them to peel off from each other. For example, insufficient adhesion between the polycarbonate-based resin and polyurethane may cause the polyurethane to peel off from the polycarbonate-based resin upon external impact, photo-decomposition, or the like.

Furthermore, when polysilicon-polycarbonate (as illustrated FIG. 2) is used to increase the adhesion of polyurethane, the haze with reduced transmittance may occur.

In other words, when polysiloxane polycarbonate (as illustrated FIG. 2) is used, a thick molded article can have low transmittance and haze, which may make it difficult to be used as a LiDAR sensor cover.

The present disclosure is intended to solve the problems described above and an objective of the present disclosure is to provide a polycarbonate-based resin composition having excellent adhesion with polyurethane and polymer having a carbonyl functional group while maintaining the original transmittance of the polycarbonate, and a molded article including the same.

An aspect of the present disclosure provides a polycarbonate-based resin composition for a light detection and ranging (LiDAR) cover, the polycarbonate-based resin composition including a polycarbonate resin and an isosorbide resin.

The isosorbide resin can include an amine functional group represented by Chemical Formula 1 or 2 below.

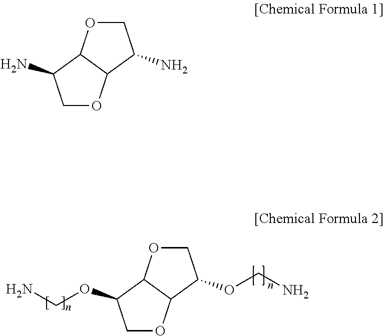

n in Chemical Formula 2 can range from 2 to 5.

In some implementations, the isosorbide resin can be added in an amount of 0.5 wt % or more to 1.0 wt % or less based on the total wt % of the composition. In some implementations, the isosorbide resin can be present in an amount of 0.5 wt % or more to 1.0 wt % or less based on the total wt % of the composition.

In some implementations, the polycarbonate-based resin can have a viscosity average molecular weight of 17,000 to 30,000.

In some examples, the composition can further include a colorant in an amount of 0.1 wt % or more to 1.0 wt % or less based on the total wt % of the composition.

In some examples, the composition can further include one or more additives selected from ultraviolet absorbers, heat stabilizers, antioxidants, active agents, flame retardants, and flame retardant auxiliaries in an amount of 1 wt % or more to 10 wt % or less based on the total wt % of the composition.

In some examples, such a polycarbonate-based resin composition can be extruded or injection molded to produce a molded article.

Another aspect of the present disclosure provides a light detection and ranging (LiDAR) cover including: a base layer; a film layer bonded onto the base layer; and a protective layer bonded onto the film layer, wherein the base layer includes a polycarbonate resin and an isosorbide resin.

In some examples, the isosorbide resin can include an amine functional group represented by Chemical Formula 1 or 2 below.

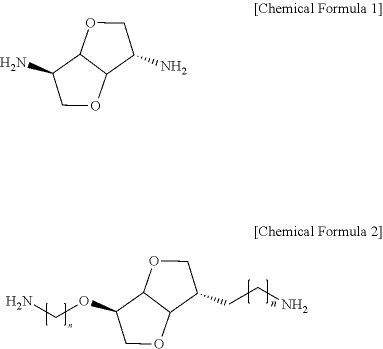

n in Chemical Formula 2 can range from 2 to 5.

In some implementations, the protective layer can be made of polyurethane.

In some implementations, the film layer can include a polymer with a carbonyl functional group.

### BRIEF DESCRIPTION OF THE DRAWINGS

FIG. 1 illustrates an example of a polycarbonate (PC)-based resin composition for a light detection and ranging (LiDAR) cover.

FIG. 2 illustrates an example of a previously known PC-based resin composition.

FIGS. 3 to 5 illustrate examples of isosorbide additives that can be added to a PC resin composition for a LiDAR sensor cover.

FIG. 6 illustrates an example of a mechanism of improving adhesion between two kinds of polymers and polycarbonate.

FIG. 7 illustrates an example of a mechanism of improving adhesion between polycarbonate and polyurethane.

FIG. 8 illustrates an example of a mechanism of improving adhesion between two kinds of polymers and polycarbonate.

### DETAILED DESCRIPTION

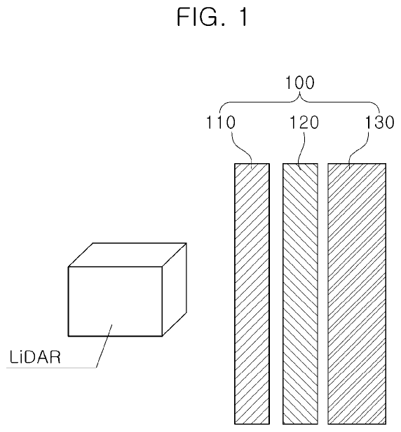

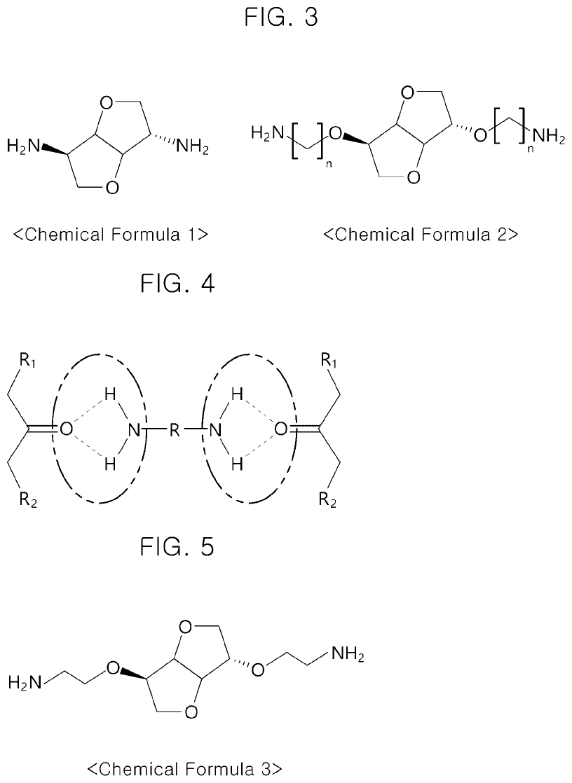

FIG. 1 schematically illustrates a polycarbonate (PC)-based resin composition for a light detection and ranging (LiDAR) cover, and FIGS. 3 to 5 respectively illustrate isosorbide additives that can be added to the PC resin composition for a LiDAR sensor cover.

Referring to FIG. 1, the LiDAR sensor cover selectively passes infrared light in a specific wavelength range and reflects visible light to help sensing a LiDAR signal. In achieve this function as a LiDAR sensor cover while enhancing integration with the exterior design of the vehicle, a film layer 120 can be laminated on a base layer 110 that is made of thermoplastic polycarbonate (PC)-based resin, and a protective layer 130 can be applied over or coated on the film layer 120 for the protection of the film layer 120.

In some implementations, the film layer 120 can serve as a design pattern or a pattern film that can incorporate metallic colors, three-dimensional (3D) shapes, or the like.

In some examples, the protective layer 130 can be made of polyurethane (PU), which can exhibit self-restoring performance to protect the cover from external factors such as impact.

In addition to polyurethane, the protective layer 130 can be made of a self-restoring material having a LiDAR transmittance of 80% or more.

Accordingly, such configurations can be applied to a vehicle grille, for example, to optimize sensor functionality while matching the vehicle design, and the film layer 120 of insert film and urethane can be used to ensure smooth operation of the LiDAR sensor while enhancing the exterior design of the vehicle.

Hereinafter, the PC-based resin composition for a LiDAR sensor cover according to an implementation of the present disclosure will be described with reference to FIGS. 1 and 3.

The present disclosure is directed to a polycarbonate-based resin composition for a LiDAR sensor cover including a base layer 110, a film layer 120, and a protective layer 130. Particularly, the polycarbonate-based resin composition can be used to form the base layer.

In particular, the present disclosure is directed to a polycarbonate-based resin composition having excellent adhesion with polyurethane and a polymer having a carbonyl functional group while maintaining the original transmittance of the polycarbonate material, and a LiDAR sensor cover including the polycarbonate-based resin composition.

Specifically, an isosorbide additive with an amine functional group expressed by Chemical Formula 1 of FIG. 3 and Chemical Formula 2 of FIG. 4, for example, can be added to the polycarbonate resin composition to improve adhesion with polyurethane and metallic film.

Thus, the adhesion of a polyurethane coating layer to a polycarbonate-based resin molded article can be improved, and the adhesion between the polycarbonate-based resin molded article and the metallic film surface can be improved.

The amine functional group can also be expressed by Chemical Formulas of FIGS. 4 and 5. Thus, n in Chemical Formula 2 can range from 2 to 5.

In the present disclosure, a polycarbonate-based resin molded article can exhibit good adhesion with two different kinds of polymers.

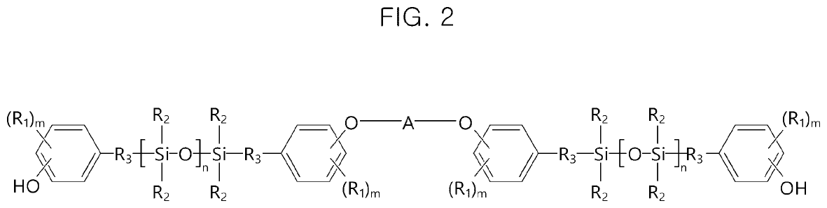

In some examples, a previously known polycarbonate-based resin (as illustrated in FIG. 2) may have problems after insert injection of the polycarbonate-based resin and metallic film. Due to poor adhesion, the metallic film may peel off from the polycarbonate-based resin molded article, and the polyurethane coated on the polycarbonate-based resin molded article may peel off from the polycarbonate-based resin molded article upon external impact and decomposition due to long-term heat and light.

To solve these problems, the amine-containing isosorbide can be added to increase the adhesion with polyurethane and with carbonyl-containing polymer, thereby exhibiting improved transmittance compared to the previously known polycarbonate-based resin.

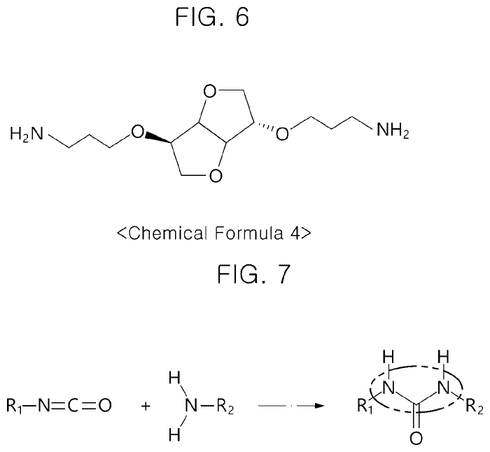

FIG. 6 illustrates an example of a method of improving adhesion with two kinds of polymers.

The adhesion between the polycarbonate-based resin and the metallic film can be improved through hydrogen bonding of the amine of the isosorbide on the surface of the polycarbonate-based resin molded article with the carbonyl functional group of the metallic film.

FIG. 7 illustrates an example of a mechanism of improving adhesion between the polycarbonate and the polyurethane.

The adhesion is improved through reactive bonding of the isocyanate with amine of the isosorbide during the coating of the polyurethane.

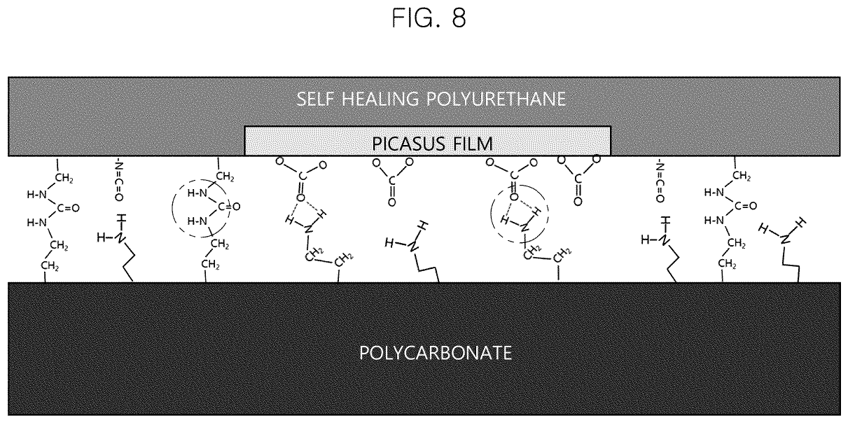

FIG. 8 illustrates an example of a mechanism of improving adhesion between two kinds of polymers and the polycarbonate.

The amine functional group on the surface of the polycarbonate react with the isocyanate of the polyurethane to form urethane, and in the case of PICASUS™ film, a hydrogen bond with the carbonyl functional group is formed to improve the adhesion.

More specific implementations and comparative examples are shown in Table 1.

TABLE 1

| | Comparative Examples | | | | Examples | | | |
|---|---|---|---|---|---|---|---|---|
| Component | #1 | #2 | #3 | #4 | #1 | #2 | #3 | #4 |
| Polycarbonate | 98.8 | | 98.3 | 97.8 | 98.2 | 97.8 | 98.2 | 97.8 |
| Polysiloxane | | 98.8 | | | | | | |
| Polycarbonate | | | | | | | | |
| Chemical Formula 1 | | | | | 0.5 | 1.0 | | |
| Chemical Formula 2 | | | | | | | 0.5 | 1.0 |
| 4,7,10-Trioxa-1,13- | | | 0.5 | 1.0 | | | | |
| tridecanediamine | | | | | | | | |
| Colorant | 1.0 | 1.0 | 1.0 | 1.0 | 1.0 | 1.0 | 1.0 | 1.0 |
| Adhesion evaluation | 2B | 4B | 3B | 4B | 3B | 4B | 5B | 5B |
| (Tape test) | | | | | | | | |
| Impact strength (IZOD | 55 | 58 | 25 | 15 | 54 | 49 | 51 | 46 |
| D180, KJ/m²) | | | | | | | | |
| Transmittance | 85 | 80 | 85 | 85 | 86 | 87 | 86 | 87 |
| (Thickness 4 mm, %) | | | | | | | | |

The isosorbide additive of less than 0.5 wt. % does not have the effect of improving adhesion, which is the main effect of the present disclosure, and the isosorbide additive of more than 1.0 wt. % results in a sharp reduction in impact strength, so it is preferred that the isosorbide additive be 0.5 wt. % or more to 1.0 wt. % or less.

(A) Polycarbonate can have a viscosity average molecular weight of 17,000 to 30,000, and a polycarbonate resin (TRILOY 3017PJ, Samyang) having a viscosity average molecular weight of 17,000 was used.

(B) Polysiloxane carbonate employs a polysiloxane carbonate resin (ST12-3022PJ, Samyang) with a viscosity average molecular weight of 20,000.

(C-1) In a reactor under an argon atmosphere, tert-amyl alcohol solvent, 1 mmol of isosorbide, [Ru(CO)ClH(PPh3)3] (0.06 mmol), and acetylacetonate (17.3 mg, 0.03 mmol) were added and dissolved. Next, 0.6 g of ammonia cooled by dry ice was added in the reactor and stirred at 170° C. for 20 hrs. The solvent was removed under pressure reduction and the remaining residue was dissolved in methanol. When the residue was loaded onto an Isolute SCX-2 column (2 g/15 mL, Biotage) and washed with tert-amyl alcohol, the isosorbidiamine (Chemical Formula 1) remained on the column, and when the remained isosorbidiamine was dissolved in methanol and then vaporized, the substance as expressed by Chemical Formula 1 was obtained.

(C-2) 2,5-Bis-O-(3-aminopropyl) isosorbide (BAI): 2,5-Bis-O-(3-aminopropyl) isosorbide of Chemical Formula 2 was prepared by the method described in the implementation of U.S. Patent Application Publication No. 2010-0130759.

(D) 4,7,10-Trioxa-1,13-tridecanediamine: A Sigma-Aldrich product was used as the monomer for comparison with isosorbide.

(E) Colorant: Solvent Green 28, a dye capable of blocking a broad band of visible light below 905 nm, was used. The colorant preferably ranges from 0.1 to 1 wt %.

(F) Polyurethane: PU 475 (KLB KOTZTAL) was used to evaluate adhesion to polyurethane.

The composition can further include one or more additives selected from UV absorbers, heat stabilizers, antioxidants, active agents, flame retardants and flame retardant auxiliaries in an amount of 1 wt % or more to 10 wt % or less based on the total wt % of the composition.

When polyurethane is coated on the polysiloxane-polycarbonate (Comparative Example 2), the composite exhibits low transmittance, and when polyurethane is coated on an example of other previously known polycarbonate-based resin (Comparative Example 1), the composite exhibits poor adhesion.

Furthermore, when a structure that contains an amine functional group, but does not have an isosorbide structure, is applied, the composite exhibits a significant reduction in impact strength (Comparative Examples 3 and 4).

In the present disclosure, isosorbide additives with amine functional groups are added so that the composite exhibits excellent adhesion and higher transmittance than the previously known polycarbonate-based resin. The employment of the isosorbide structure can minimize the deterioration of the impact strength caused by the addition of polycarbonate additives.

Then, for each specimen manufactured by an injection method with the polycarbonate-based resin composition for LiDAR, the physical properties were measured by the following method, and the results are shown in the table above.

IZOD impact strength (KJ/m²): Specimens were measured at room temperature (23° C.) according to ISO 180.

Transmittance: 4 mm thick specimens were measured using a UV-Vis spectrometer at a wavelength of 905 nm.

Polyurethane adhesion evaluation; Specimens were prepared by coating a 1 mm thick layer of polyurethane solution on a polycarbonate substrate (size: 5×10 cm²) with a spin coater and curing the coated layer in an oven at 80° C. for 5 minutes.

Adhesion evaluation (0-5B): Specimens were evaluated by ASTM D3359 method.

As shown in Table 1 above, Examples 1 to 4 of the present disclosure exhibited superior mechanical property improvements in adhesion, impact strength, and transmittance as compared to the comparative examples.

Particularly, Examples 1 and 4 showed excellent adhesion compared to Comparative Example 1, which does not contain the isosorbide additive according to the present disclosure. The reason for using the isosorbide additive is that the material of Comparative Examples 3 and 4, which is an additive 4,7,10-Trioxa-1,13-tridecanediamine with an amine functional group, improves adhesion but reduces the impact strength of polycarbonate, so the additive has the disadvantage that it is difficult to use as an additive to improve adhesion, whereas the isosorbide additive has the advantage of improving adhesion while minimizing the deterioration of the impact strength.

In addition, the polycarbonate-based resin for LiDAR requires high transmittance because light of the LiDAR sensor needs to be transmitted, and compared to the polysiloxane carbonate Comparative Example 2, which has excellent adhesion, the adhesion is similar, but the transmittance is high at a thickness of 4 mm, and the transmittance is improved when the isosorbide additive is added.

In some implementations, the polycarbonate-based resin composition as described above can be extruded or injection molded to produce a molded article for a LiDAR sensor cover.

While the foregoing disclosure has been described with reference to the illustrative drawings, it will be apparent to those of ordinary skill in the art that it is not limited to the implementations described, and that various modifications and variations can be made without departing from the spirit and scope of the present disclosure. Accordingly, such modifications or variations should be considered as falling within the scope of the claims of the present disclosure, and the claims of the present disclosure should be construed based on the appended claims.

What is claimed is:

1. A polycarbonate (PC)-based resin composition for a light detection and ranging (LiDAR) sensor cover, the PC-based resin composition comprising:
a polycarbonate resin; and
an isosorbide resin.

2. The PC-based resin composition of claim 1, wherein the isosorbide resin comprises an amine functional group represented by Chemical Formula 1 or 2 below:

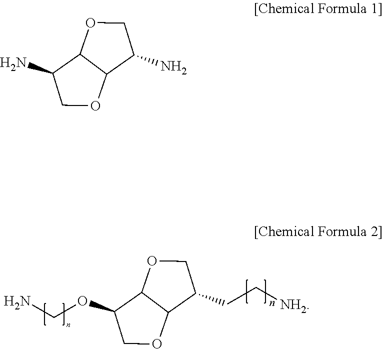

3. The PC-based resin composition of claim 2, wherein n in Chemical Formula 2 ranges from 2 to 5.

4. The PC-based resin composition of claim 2, wherein the isosorbide resin is present in an amount that is greater than or equal to 0.5 wt % and less than or equal to 1.0 wt %, based on a total wt % of the PC-based resin composition.

5. The PC-based resin composition of claim 2, wherein the polycarbonate resin has a viscosity average molecular weight that is greater than or equal to 17,000 and less than or equal to 30,000.

6. The PC-based resin composition of claim 2, further comprising:
a colorant in an amount that is greater than or equal to 0.1 wt % and less than or equal to 1.0 wt %, based on a total wt % of the PC-based resin composition.

7. The PC-based resin composition of claim 2, further comprising:
one or more additives selected from ultraviolet absorbers, heat stabilizers, antioxidants, active agents, flame retardants, and flame retardant auxiliaries,
wherein the one or more additives is present in an amount that is greater than or equal to 1 wt % and less than or equal to 10 wt %, based on a total wt % of the PC-based resin composition.

8. A molded article manufactured by extruding or injection molding a polycarbonate (PC)-based resin, the molded article comprising:
a molded surface comprising the PC-based resin,
wherein the PC-based resin comprises a polycarbonate resin and an isosorbide resin.

9. The molded article of claim 8, wherein the isosorbide resin comprises an amine functional group represented by Chemical Formula 1 or 2 below:

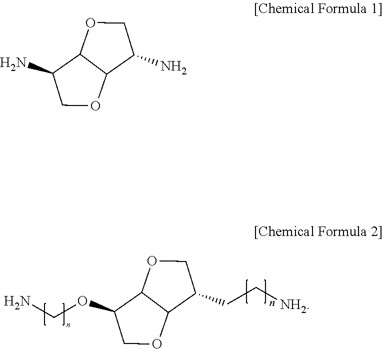

10. The molded article of claim 9, wherein n in Chemical Formula 2 ranges from 2 to 5.

11. The molded article of claim 9, wherein the isosorbide resin is present in an amount that is greater than or equal to 0.5 wt % and less than or equal to 1.0 wt %, based on a total wt % of the PC-based resin.

12. The molded article of claim 9, wherein the polycarbonate resin has a viscosity average molecular weight that is greater than or equal to 17,000 and less than or equal to 30,000.

13. The molded article of claim 9, wherein the PC-based resin further comprises a colorant in an amount that is greater than or equal to 0.1 wt % and less than or equal to 1.0 wt %, based on a total wt % of the PC-based resin.

14. The molded article of claim 9, wherein the PC-based resin further comprises one or more additives selected from ultraviolet absorbers, heat stabilizers, antioxidants, active agents, flame retardants, and flame retardant auxiliaries, and
wherein the one or more additives is present in an amount that is greater than or equal to 1 wt % and less than or equal to 10 wt %, based on a total wt % of the PC-based resin.

15. A light detection and ranging (LiDAR) sensor cover comprising:
a base layer;
a film layer bonded onto the base layer; and
a protective layer bonded onto the film layer, wherein the base layer comprises a polycarbonate resin and an isosorbide resin.

16. The LiDAR sensor cover of claim 15, wherein the isosorbide resin comprises an amine functional group represented by Chemical Formula 1 or 2 below:

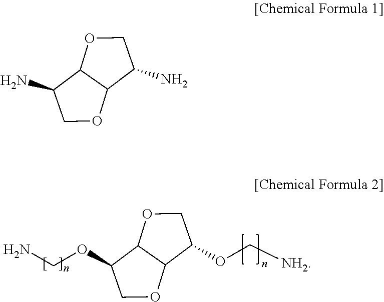

17. The LiDAR sensor cover of claim 16, wherein n in Chemical Formula 2 ranges from 2 to 5.

18. The LiDAR sensor cover of claim 16, wherein the protective layer is made of polyurethane.

19. The LiDAR sensor cover of claim 16, wherein the film layer comprises a polymer with a carbonyl functional group.

20. The LiDAR sensor cover of claim 16, wherein the isosorbide resin is present in an amount that is greater than or equal to 0.5 wt % and less than or equal to 1.0 wt %, based on a total wt % of the polycarbonate resin and the isosorbide resin.
